(19) United States
(12) Patent Application Publication
(10) Pub. No.: US 2009/0223109 A1
(43) Pub. Date: Sep. 10, 2009

(54) Lure Light for Illuminating Lure While Fishing

(76) Inventor: James Makowski, Sterling, NY (US)

Correspondence Address: BERNHARD P. MOLLDREM, JR., 224 HARRISON STREET, SUITE 200, SYRACUSE, NY, 13202, US

(21) Appl. No.: 12/470,599

(22) Filed: May 22, 2009

Related U.S. Application Data
(63) Continuation-in-part of application No. 11/507,129, filed on Aug. 21, 2006.
(60) Provisional application No. 60/709,915, filed on Aug. 22, 2005.

(51) Int. Cl. A01K 85/01

(52) U.S. Cl. 43/17.6; 43/17.5

(57) ABSTRACT

A downrigger light attractor device is positioned on a downrigger cable, between the downrigger weight and the release device that holds the fish line. The lure light illuminates the trailing lure at depths or at night. The device preferably has a generally flat vertical body with a cylindrical lamp chamber, including a battery compartment formed unitarily with the flat body, and a sealed capsule or end cap, containing an LED, that screws into a threaded aft end of the battery compartment. A nose fin ahead of the lure light vertical axis can provide some desirable wobble. A scent or fish attractant can be dispersed from a barrel member formed above the lamp compartment.

This is a Continuation-in-Part of my co-pending U.S. patent application Ser. No. 11/507,129, filed Aug. 21, 2006, which claims priority of provisional application No. 60/709,915, filed Aug. 22, 2005.

### BACKGROUND OF THE INVENTION

This invention relates to a method and device for illumination of colorful lures in deep water, by means of a water-tight or waterproof light that attaches onto the downrigger cable or wire ahead of the lure.

The invention is more particularly concerned with a small lighting device that can shine a beam of light on a lure underwater, which can be a steady light, flashing light, white, or any of various colors, or can be black light for illuminating a phosphorescent lure.

A typical version of a lure light is shown in Caprio U.S. Pat. No. 5,987,802. These are intended for fishing at or near the surface, e.g., when drift fishing for swordfish at night. The lure light is attached onto the fishing line, in line with the lure. With the lure light attached directly onto the fishing line, the lure light is often lost if the fish snaps the line and takes the lure and lure light with it. Also, the Caprio device requires it to be used in salt water, as salt water completes the circuit necessary to allow current to flow to the lighting device.

Many types of sport fish, such as salmon, may be present at any of various depths, especially in deep water such as in the Great Lakes. At significant depths, daylight fails to penetrate. At those depths, a fishing lure would be hardly visible. However, no one has proposed a system in which the lure light would be a part of the downrigger apparatus, coupled onto the downrigger wire between the downrigger weight (at the bottom of the downrigger wire) and the fish line release, situated some distance above the downrigger weight. One proposed downrigger weight and release system, as described in Smith U.S. Pat. No. 5,412,897 has a light transmitter and sonar transducer incorporated into the downrigger weight, with the sonar transducer being used to sense for the bottom below the weight, and the light transmitter being directed upward, parallel with the downrigger wire, to transmit this bottom information to a display in the boat. However, there is no provision for a light device to illuminate a lure on the fishing line, and no provision for a lure light secured to the downrigger wire in a position between the weight and the release, and with the light oriented at about ninety degrees from the vertical or downrigger wire axis, so as to direct its beam onto a lure trailing behind the downrigger wire.

### OBJECTS AND SUMMARY OF THE INVENTION

It is an object to provide a means for illuminating lures when underwater, and which is durable, simple to use, and can be kept in a tackle box and installed on the fishing line when needed.

In accordance with an aspect of this invention, a lure light has a water-tight housing that contains a small lamp, e.g., an LED or laser diode, or in some cases could be a small incandescent lamp. This is powered by a stack of two or more small watch battery cells, or by a small photographic battery. As an option, the device can include a switch to turn it on when it is being pulled through the water, i.e., when trolling. In some preferred versions, there can be a chamber containing wicking that holds a scent and with small openings or apertures that allow the scent into the water to attract fish. There may also be a chamber containing small shot or other items to create clicking or rolling sounds when the device is pulled through the water.

In one possible version, at the leading side of the device there is a screw closure with a swivel clip for attaching to the line, and which closes over an O-ring seal. This can be tightened down to turn it on and twisted the other direction to turn it off. Otherwise, there can be any other sort of switch, such as a pressure switch that turns on if the device is being trolled below some depth, e.g., at 30 feet or more, or there can be a water sensor switch that turns on when the lure light is immersed.

In some embodiments, the lure light can have interchangeable lenses at the lighted end, so that the color can be changed as needed for different fishing conditions. In that case, the lamp or lighting device could be a so-called “white” LED.

In practice, downrigger light attractor can be attached at the down-rigger wire above the weight or Dipsy Diver, i.e., at a point below the release, where it will light the fishing tackle that trails behind, such as a “flasher” as well as the lure or bait. In some cases, the lure light can be attached at the flasher, or even onto the fishing line about 16 to 24 inches ahead of the lure.

In one preferred embodiment, the downrigger light attractor is combined with a deepwater fishing rig for use in deep water fishing. The rig includes a downrigger wire (or cable) extending vertically into the water, a downrigger weight carried at a lower end of the wire, and a release device carried on the downrigger wire at a position above the downrigger weight. A fishing line carrying a fishing lure is held in the release device. The latter holds fishing line in place at depth but allows the line to pull free of the release device when a fish strikes said lure. The downrigger light attractor is connected onto the downrigger wire below the release device and above the downrigger weight.

In this case, the lure light has a body portion and an attachment arrangement that extends from opposite sides (i.e., top and bottom) of the body portion, and connects on an upper side to a portion of wire going upwards to the release device and at a lower side to a portion of the wire that extends downwards to the downrigger weight. The attachment arrangement thus defines a vertical axis for the lure light body portion. (The line of the downrigger wire is considered “vertical” although in actuality the wire will be inclined a few degrees due to drag.)

A watertight, generally tubular chamber is incorporated into the body portion, and this tubular chamber extends in a direction radially rearward from the vertical axis. The watertight chamber includes a lamp device disposed at a radially outward end of the chamber (i.e., the end facing back towards the lure, and away from the travel direction). The lamp is adapted to project a cone of light, i.e., visible light or ultraviolet light in the case of a fluorescent, in a rearward direction that is substantially at a right angle to the vertical axis, i.e., at a right angle to the downrigger wire. A battery or similar means within the chamber provide electrical power to the lamp device. In this arrangement, the light emanating from lamp shines rearwardly (and slightly upwardly) onto the lure to make the lure visible to fish, and the lure light remains on the downrigger wire when the fishing line pulls free from the release device.

Preferably, the watertight chamber is comprised of a battery chamber portion adapted hold the electrical battery. The battery chamber has a threaded opening at its rearward end. A sealed lamp compartment, in the form of a screw-in end cap containing the lamp, has a threaded cylindrical member therein with threads to mate with the threaded opening of the battery chamber portion. There are electrical contacts positioned on this threaded cylindrical member to contact the battery electrically when the end cap is screwed into place. A transparent dome portion contains the lamp device. A flange member joins the cylindrical member and the dome portion. A sealing member positioned between said flange member and the rearward end of said battery chamber portion to form a watertight seal when said end cap is screwed into place. There may be a seal ring positioned at the rear face of the battery chamber portion that seals against the flange member when the end cap is screwed in. All the electrical connections and circuitry is within the water-tight chamber(s).

Favorably, the lamp emits visible light, and includes a white LED sealed within the dome portion of the end cap. Alternatively, the lamp device can provide black light illumination adapted for illuminating a phosphorescent lure.

In a favorable construction, the body portion of the downrigger light attractor includes a flat plate that is disposed in a vertical plane with the vertical axis passing through it. The battery chamber portion of the watertight lamp chamber is formed unitarily with the flat plate. The body portion can also include a fish attractant chamber formed unitarily on said flat plate, including means, such as a sponge member, for retaining a liquid fish attractant and dispersing the fish attractant into the water while fishing. The flat plate of the body portion further can also include a nose fin extending to a forward side of the vertical axis. The lure light device is compact and lightweight, fitting easily into a tackle box when not deployed, and is intended not to affect the down force and drag of the downrigger arrangement.

A few preferred embodiments of this invention will be described below, with reference to the accompanying Drawing figures.

### BRIEF DESCRIPTION OF THE DRAWING

FIG. 1 is an environmental view for explaining the use of the lure light according to one embodiment of this invention

FIG. 2 is a perspective view of the lure light this embodiment.

FIG. 3 is a top plan view thereof.

FIG. 4 is a side view thereof.

FIG. 5 is a is a proximal view, i.e., rear view of the lure light of this embodiment.

FIG. 6. Is a distal or front view thereof.

FIG. 7 is a perspective view of the lure light according to another embodiment of the invention.

FIG. 8 is a proximal view of the lure light of this embodiment.

FIG. 9 is an exploded assembly view of the lure light of this embodiment.

FIG. 10 shows an alternative embodiment.

FIG. 11 is another environmental view illustrating implementation of this invention.

FIG. 12 is an environmental view illustrating an implementation of another embodiment of the invention.

FIG. 13 is a side elevation of the downrigger light attractor shown in FIG. 12.

FIGS. 14 and 15 are respective front and rear elevations of the downrigger light attractor of this embodiment.

### DETAILED DESCRIPTION OF THE PREFERRED EMBODIMENT(S)

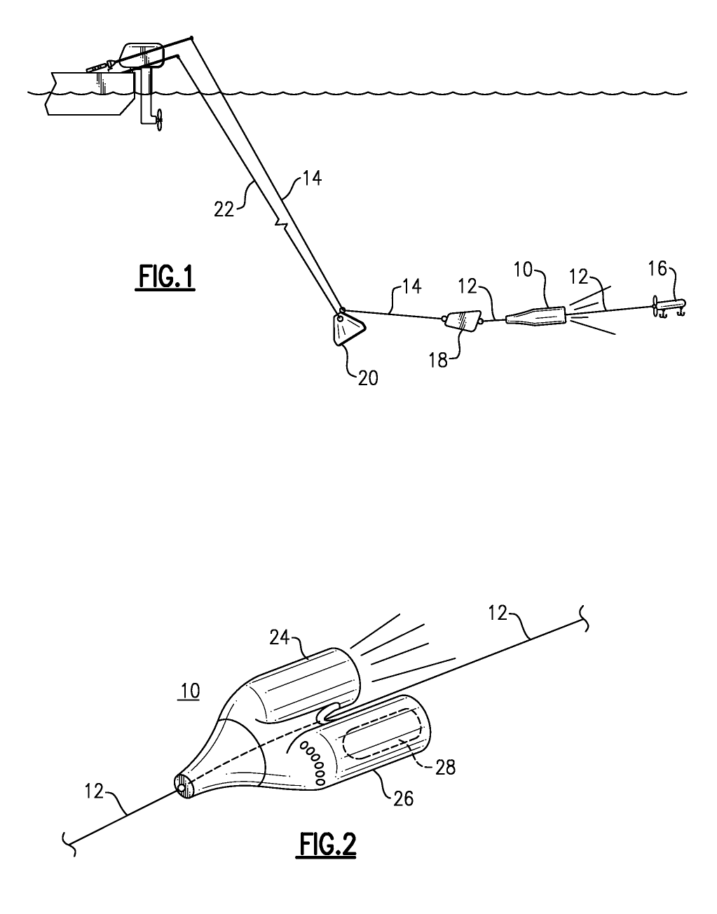

With reference to the Drawing, and initially to FIGS. 1 and 2, a lure light 10 according to one embodiment of this invention is mounted on a wire leader 12 on a fishing line 14, in advance of a lure 16. The lure light device 10 is placed in a position on the leader 12 to illuminate the lure 16, or alternately to illuminate a flasher placed between the line and the leader. In this example, the fishing line is taken down to depth by means of a downrigger weight or Dipsy Diver 20 or other similar mechanism that is held by a separate wire 22 to the boat. The line 14 is held to the downrigger equipment by means of a release mechanism, so the line pulls free of the downrigger if a fish strikes. The lure light could be used with any type of lure, e.g., plug, fly, spoon, spinner, or cut bait, but is especially useful when the natural light illuminating the lure is very weak, i.e., at significant depths or at night. Here the flasher 18 is located in advance of the lure light, but the flasher could be placed between the lure light and the lure. Alternatively, and additional lure light could be used in advance of the flasher as well.

As shown in FIG. 2, the lure light device 10 has a case formed as a pair of generally cylindrical chambers or barrels 24, 26. One of these barrels 24 is a light cylinder that contains an LED and a number of power cells, e.g., watch battery cells. The other barrel 26 is a scent cylinder that holds a piece of wicking 28 that contains a scent or fish attractant. There are small openings or apertures 30 that permit the water to flow through and pick up this scent. The wire leader 12 passes through an opening in a front end or nose 32 of the case and through an opening at the rear between the two cylinders.

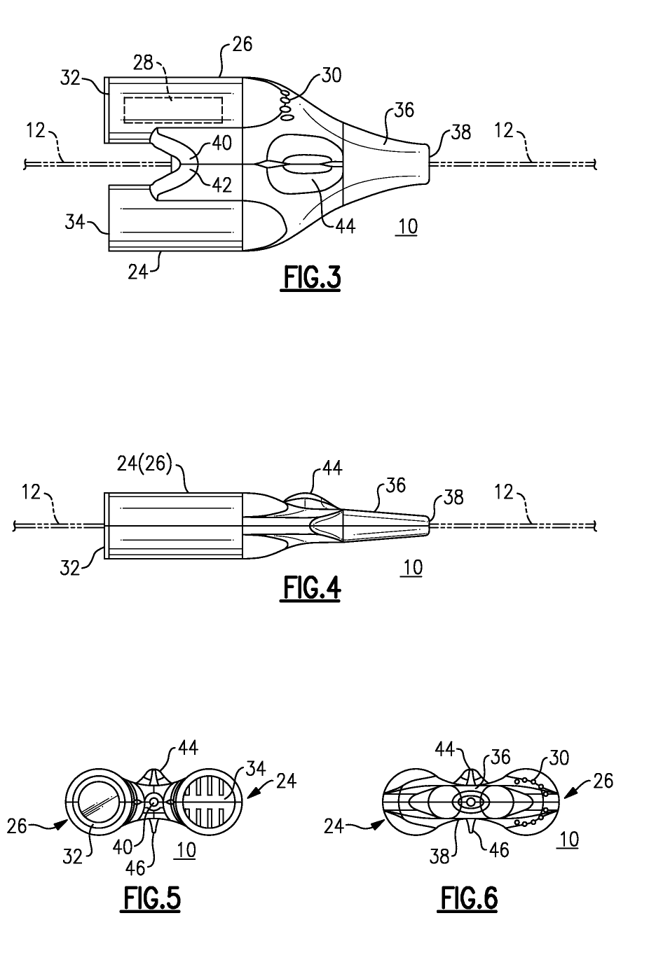

Details of the case of this lure light can be seen in FIGS. 3 to 6. As aforementioned, the lure light has a case formed of a light cylinder barrel 24 and a scent cylinder barrel 26.

The scent cylinder or barrel 26 has apertures 30 at its anterior or distal end, and there is a cap 32 with closing off the proximal or posterior end. The cap can be removed, and the wick 28 can be pulled out and treated with a few drops of a fish attractant (scent), and then wick and cap can be replaced. The apertures allow a small quantity of water to flow in and out of the cylindrical chamber so that the attractant is presented to fish in the vicinity.

The light cylinder or barrel 24 has a lens 34 covering the proximal or posterior end, and sealing off the cylindrical chamber, which contains one or more LEDs, a set of two or three watch battery cells, and optionally, electronics for flashing or other effects. The lens 34 can serve to confine the beam of light so that it concentrates on the lure. A colored lens may be used.

The body of the lure light also has a forward pointed nose 36 positioned between the two cylinders 24, 26. There is an opening 38 at the forward tip of the nose, and there is another opening 40 located at the rear of the lure light between the two cylinders or barrels. A steel cable that serves as leader 12 passes through a bore or passage between the front and rear openings 38 and 40. The steel cable runs through the device, and connects to the fish line 14 in advance of the device and to the lure 16 behind. There is a switch mechanism 42 located within the device that turns on when there is tension on the cable 12 from the lure 16 being dragged through the water. This switch mechanism can be off normally.

FIG. 11 shows a deep water fishing arrangement where the lure light device 10 is affixed to the downrigger 20 on the downrigger wire 22, and is separate from the fishing line 14. In this position, the light illuminates the lure 16 and the flasher 18. The lure light device 10 remains on the downrigger when a fish is reeled in. An alternative position with a lure light device on the fish line 14 is illustrated as 10′.

Also, within the lure light device 10 is a small chamber containing round shot, which will rattle as the device moves through the water. The sound being produced is believed to attract fish. At the upper side of the nose 36 is a bulge or dome-like protuberance 44, and there is a fin or skeg 46 projecting from the underside of the nose 36 (see FIGS. 5 and 6). These features help to stabilize the lure light and the lure as they move through the water.

In this embodiment, the lure light device 10 has a negative buoyancy, and the device is typically placed a distance of 24 to 36 inches in advance of the lure 16.

The lure light device in this case has dimensions of about 3¾ inches long, about 2 inches across, and about ¾ inches thick, that is, the barrels have a diameter of about ¾ inch. However, the invention is not limited to lure light devices of that size, and these may be larger or smaller, depending upon the equipment and fishing tackle that it is used with.

The device can be of different shapes and configurations, and in some embodiment can omit the shot chamber or can omit the scent barrel.

In one possible arrangement, an additional lure light 10 can attached to the release of the downrigger, where its light can illuminates a flasher in advance of the other lure light, with the flasher being a flat blade type of equipment, and positioned several feet behind the downrigger.

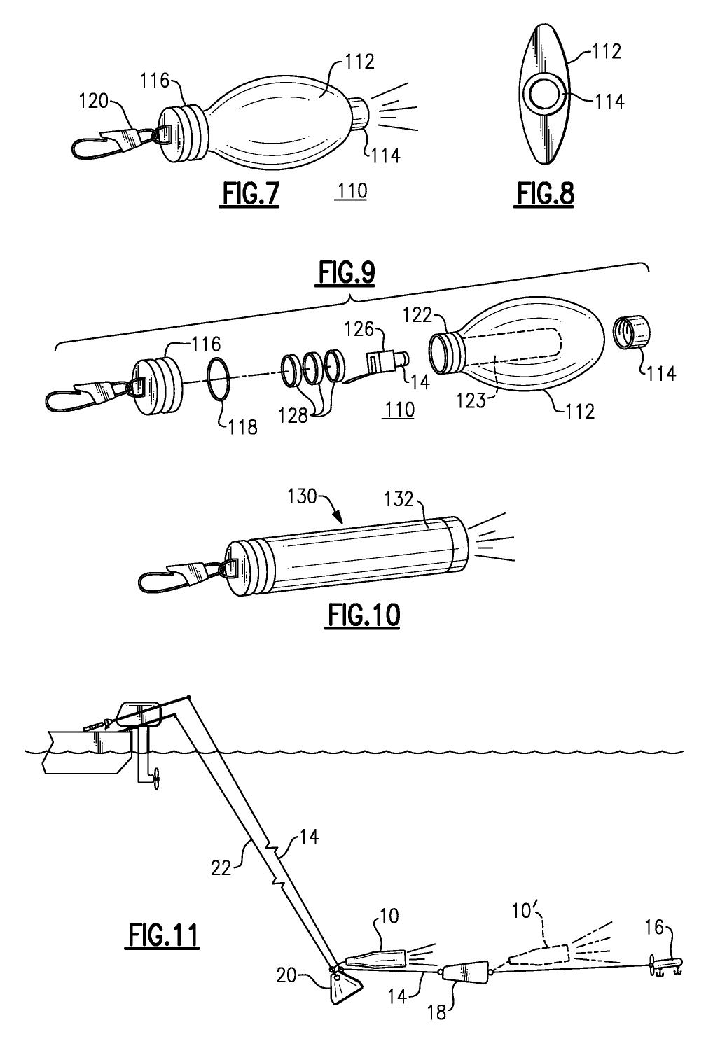

An alternative embodiment is illustrated in FIGS. 7, 8, and 9. As shown there, a lure light 110 has a watertight plastic body 112, with a transparent lens 114 at the proximal or lure end, and a cap 116 at the distal or line end. In this embodiment, there is an O-ring seal 118 that is compressed by the cap, which is threaded and screws tight against the body. A swivel clip 120 on the cap 116 is provided for attaching the lure light to the line or another part of the fishing tackle. Here, as shown in FIG. 8, the body 112 is taller than it is wide, so that it has a stable trailing action in the water. The device may be about ¾ inch to one inch in length. The body 112 may be tapered so it cuts through the water.

As shown in the exploded assembly view of FIG. 9, the body 112 has a male threaded neck 122 on which the cap and O-ring are placed, and this neck 122 leads to an internal cavity 123. An LED 124 and associated electronics package 126 fit into the cavity 213, together with a stack of small power cells 128, 128. Here, the electrical circuit of the cells 128, package 126, and LED 14 will close to turn on when the cap 116 is tightened down. This also compresses the O-ring 118 and makes the device watertight. The power cells 128 are small and inexpensive and can be changed out when they are depleted.

As shown at the proximal end, the lens 114 is fitted into a socket 129, so it can be removed and replaced with a different lens. Favorably, the device is provided with a number of lenses 114 of different colors, so the color can be changed to suit fishing conditions. In such case, the LED can be a white LED generating a spectrum of visible wavelengths, or a small incandescent lamp could be substituted.

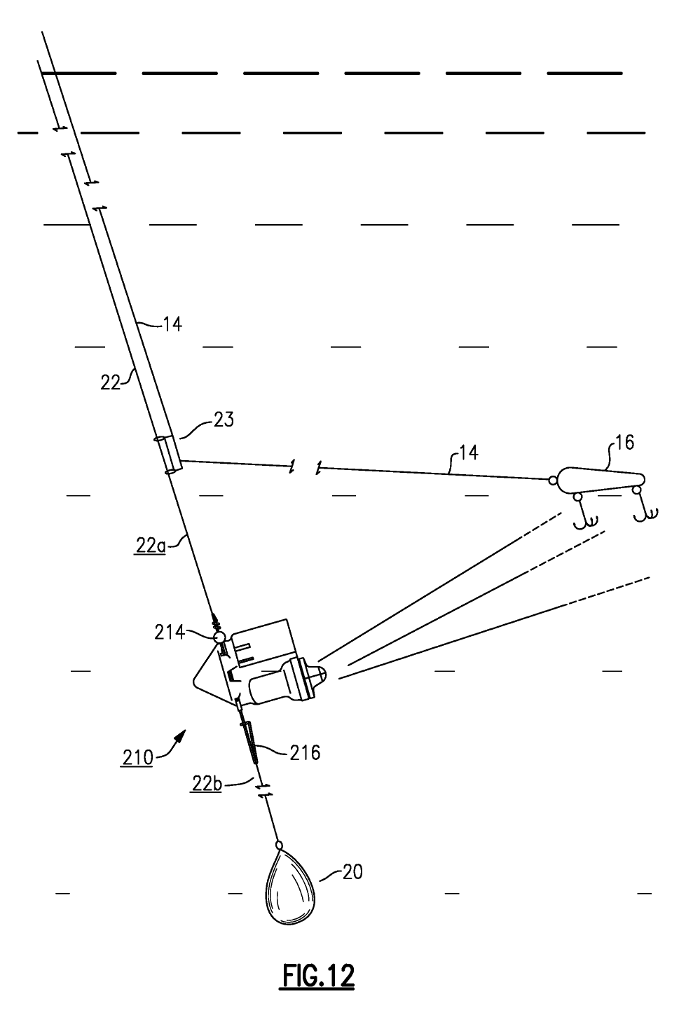

An alternative design of a lure light 130 is shown in FIG. 10. Here, the device has a body or case 132 that is in the form of a long, slim cylinder. Many other shapes and sizes could be used.

The lure light 110 or 130 of this invention is placed in a position to illuminate the lure, and can be positioned as mentioned before in advance of the lure or a attached to the flasher as described before with reference to FIG. 1. The lure light may be attached at the downrigger or Dipsy Diver, or an additional lure light may be placed at that location.

The lure light device of this invention can be used with any type of lure, e.g., plug, fly, spoon, spinner, or with live bait or cut bait.

In a preferred embodiment, the lure light is designed for a steady beam, but in other versions the lure light could produce chopped, flashing light. There can be multiple LEDs emitting different colors, or flashing from one color to another. Also, instead of the switch arrangements as described, there can be a water sensitive device to turn on in the presence of water, or a pressure switch to turn on when the device is at some depth, e.g., at fifteen feet or below. As an additional feature, the lure light can contain a sounder device as well to produce sounds such as chirps or clicks. This can be electrically powered from small cells.

Another embodiment of this invention is depicted in FIGS. 12 to 15. This embodiment has dimensions of about four inches in length, three inches in height, and about one inch in width, and does not carry an ballast or weight, so it is about neutral to slightly negative buoyancy. The downrigger light attractor device is easily accommodated in the fisherman's tackle box, and is designed no to create significant down force or drag.

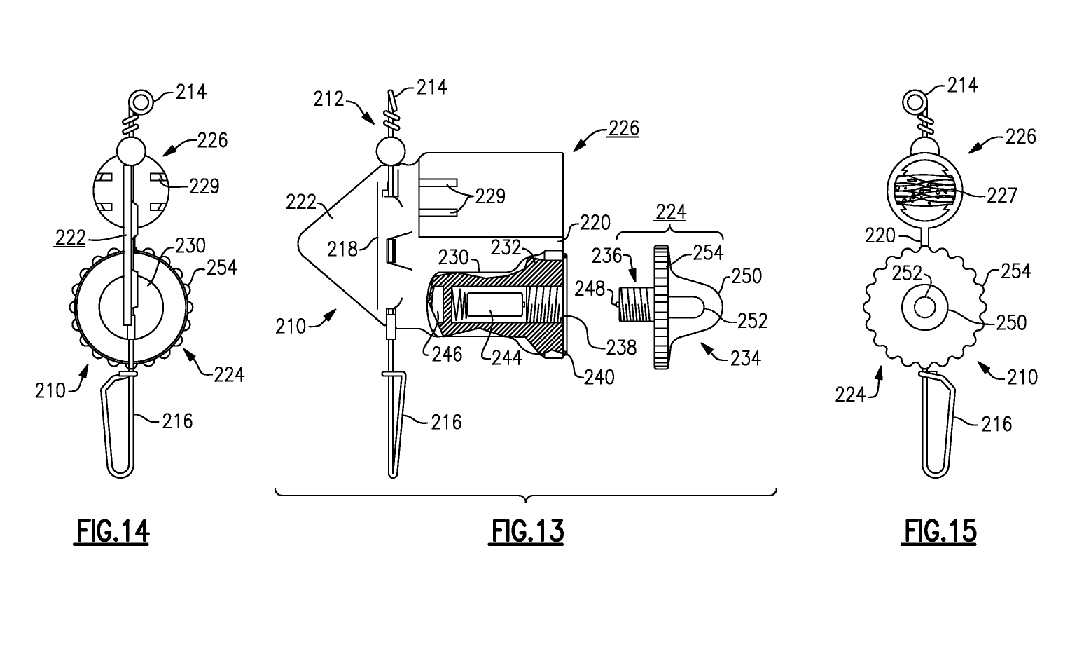

The downrigger light attractor device according to this embodiment is shown in FIG. 12, with further reference to FIGS. 13, 14, and 15. Here, the downrigger arrangement is shown with the downrigger wire or cable 22 and a downrigger weight 20 at the lower end of the wire 22, and with a fishline release device 23 affixed onto the wire 22 at some distance above the weight 20.

A downrigger light attractor device 210 of this embodiment of the invention is secured in line on the wire 22 between the downrigger weight 20 and the release device 23. The device 210 has a wire attachment arrangement 212 that extends vertically through the body of the lure light and has an attachment eye 214 disposed at its upper end, and connecting to a segment 22a of the downrigger wire 22 that extends up to the release 23. The attachment arrangement 212 also has a lower clip 216, at its lower side, and this clip 216 attaches to another segment 22b of the downrigger wire 22 that goes down to the weight 20. The attachment arrangement 212 defines a generally vertical axis for the downrigger light attractor device 210, so that a portion of the lure light device trails behind the downrigger wire and a front portion extends ahead of the downrigger wire.

The downrigger light attractor device has a body that is generally in the form of a flat plate member 218 that is vertical, i.e., in the plane of the axis defined by the attachment arrangement 212. A major portion 220 of the plate member extends aft, that is, rearward and towards the lure 16 that is trailing behind the lure light device. A forward portion of the plate member 218 projects ahead of the attachment device 212 and serves as a nose fin 222. In this embodiment, the nose fin 222 is flat and generally triangular in profile. The nose fin, which projects forward, i.e., in the direction of travel, creates a small amount of wobble as the lure light device is pulled through the water.

An illumination chamber or lamp chamber 224 is generally cylindrical in shape and is formed at the lower half of the aft portion 220 of the flat plate member 218, while a scent or attractant barrel member 226 is formed generally as a cylinder and is formed at the upper half of the aft portion 220. Both the lamp chamber 224 and attractant barrel member 226 are formed with their axes in the fore-and-aft direction. The attractant tube 226 has slots 227 through the front end to allow flow of water through it. The rear end is open, as seen in FIG. 15, and the interior space that holds a sponge or wicking member 229, here shown held between retaining ribs.

The lamp chamber 224 is designed to be water-tight. A generally cylindrical battery compartment 230 is formed unitarily with the aft portion 220 of the body flat plate member, and has a belled or widened aft portion 232. A screw-in sealed lamp capsule 234, in the form of a screw-in end cap, has a male-threaded generally cylindrical forward portion 236 that mates with a female-threaded aft portion 238 of the battery compartment 230. A seal ring 240 is shown here disposed at a flat aft face of the belled out portion 232. In this embodiment, a small 6-volt photographic cell 244 is situated within the compartment 230, as shown. A shot chamber 246 is formed at the forward end of the battery compartment, and contains pieces of shot which can rattle to make a noise believed to attract fish.

The forward end of the threaded forward cylindrical portion 236 of the end cap 234 has electrical contacts 248 to make electrical contact with the battery 244 when the end cap is screwed into place. At the opposite or aft end of the end cap there is a transparent dome portion 250, and a white LED 252 is contained within the dome portion. A flat disk-like flange 252 joins the cylindrical portion 236 with the dome portion 250. The flange 252 has a knurled rim to facilitate inserting and removing the end cap. The flange 252 also compresses the seal ring 240 against the end of the battery compartment when the end cap is screwed down, to create a water-tight seal.

In this embodiment, the entire end cap 234 is formed as a sealed module, with the LED 252 sealed permanently inside. The dome portion 250 encloses the LED and also serves as a lens to create a cone of light going generally in the aft direction, i.e., towards the lure 16.

As shown in this embodiment, the wire attachment arrangement 212 can be in the form of an elongated metal shaft that passes through the plane of the flat plate body member 218, with the eye 214 and clip 216 formed out of the shaft at its upper and lower ends. The shaft can hold a round bead or other item that may interest a fish.

While this invention has been described in detail with reference to a few selected embodiments, the invention is not limited to those embodiments. Rather, many variations would appear to those of skill in the art without departing from the scope and spirit of the invention, as defined in the appended claims.

I claim:

1. In combination, a deepwater fishing rig for use in deep water, the rig including a downrigger wire extending vertically into the water, a downrigger weight carried at a lower end of the wire, a release device carried on said downrigger wire at a position above said downrigger weight; a fishing line carrying a fishing lure; wherein said release device holds said fish line in place at depth but allows said line to pull free of the release device when a fish strikes said lure; and a downrigger light attractor device connected onto said downrigger wire below said release device and above said downrigger weight; the downrigger light attractor device including
a body portion;
an attachment arrangement extending from opposite sides of said body portion to connect on an upper side to a portion of said wire going upwards to said release device and to connect at a lower side to a portion of said wire that extends downwards to said downrigger weight, said attachment arrangement defining a vertical axis for said lure light body portion;
a watertight chamber within said body portion, and extending in a direction radially rearward from said vertical axis, the watertight chamber including a lamp device disposed at a radially outward end of said chamber and adapted to project a cone of light in a rearward direction that is substantially at a right angle to said vertical axis, and means within the chamber providing electrical power to said lamp device, such that light emanating from said lamp shines rearwardly onto said lure to make the lure visible to fish, and wherein the downrigger light attractor device remains on the downrigger wire when the fishing line pulls free from the release device.

2. The combination according to claim 1, wherein said watertight chamber includes
battery chamber portion adapted to hold an electrical battery, the battery chamber having a threaded opening at a rearward end thereof, and
a sealed screw-in end cap containing said lamp, wherein the end cap has a threaded cylindrical member thereon with threads to mate with said threaded opening; electrical contacts positioned on said threaded cylindrical member to contact said battery electrically when the end cap is screwed into place; a transparent dome portion containing said lamp device; a flange member joining said cylindrical member and said dome portion; and a sealing member positioned between said flange member and the rearward end of said battery chamber portion to form a watertight seal when said end cap is screwed into place.

3. The combination according to claim 2 wherein said lamp includes a white LED sealed within the dome portion of said end cap.

4. The combination according to claim 2 wherein the body portion of said lure light includes a flat plate disposed in a vertical plane with said vertical axis passing therethrough, and wherein the battery chamber portion of said watertight chamber is formed unitarily with said flat plate.

5. The combination according to claim 4 wherein said body portion includes a fish attractant chamber formed unitarily on said flat plate, including means for retaining a liquid fish attractant and dispersing the fish attractant into the water.

6. The combination according to claim 4, wherein the flat plate of the body portion further includes a nose fin extending to a forward side of said vertical axis.

7. The combination according to claim 1, wherein said lamp device provides black light illumination adapted for illuminating a phosphorescent lure.

8. A lure light that comprises a watertight body; a lamp device contained in said watertight body and emitting light out a proximal end thereof, means providing electrical power to the lamp device; and means at the opposite or distal end to attach to a fishing rig ahead of and in line with a lure disposed at the end of the fishing line, and positioned so that the light emanating from said lure light shines onto said lure;
said body comprising first and second barrels situated alongside one another, with said lamp device and said means providing electrical power thereto being contained in said first barrel, and wherein said second barrel includes wicking containing a fish attractant scent, such that the scent is diffused into the water ahead of said lure so that the fish attractant scent is presented to fish in the vicinity; and wherein said body has a forward-pointed nose between said first and second cylinders, including a dome-like protuberance at an upper side of said nose, and a skeg projecting from an under side of said nose.

9. A lure light according to claim 8, wherein said body has a passage therethrough, with a cable passing through said passage, the cable being adapted to attach at one end to a fishing line and at its other end to said lure.

10. A lure light according to claim 9, further comprising a switch means for turning the light on in response to tension on said cable.

11. A lure light according to claim 8, wherein said second barrel includes apertures permitting said fish attractant to be presented to fish in the vicinity of the lure light.

12. A lure light according to claim 8, said body including a shot-filled chamber.
